(19) United States
(12) Patent Application Publication
(10) Pub. No.: US 2008/0320059 A1
(43) Pub. Date: Dec. 25, 2008

(54) Database System and Method for External Backup

(76) Inventors: Andreas Schmidt, Grossostheim (DE); Harald Schoning, Dieburg (DE); Wolfgang Obmann, Darmstadt (DE)

Correspondence Address: MEYERTONS, HOOD, KIVLIN, KOWERT & GOETZEL, P.C., P.O. BOX 398, AUSTIN, TX, 78767-0398, US

(21) Appl. No.: 11/770,046

(22) Filed: Jun. 28, 2007

(30) Foreign Application Priority Data
Jun. 22, 2007 (EP) 07 012 270.0

(51) Int. Cl. G06F 17/30

(52) U.S. Cl. 707/204; 707/E17.005

(57) ABSTRACT

A database system comprising a database logic adapted to perform database processing and a backup interface for external backup, wherein the backup interface is adapted to connect the database sys-tem to a plurality of different external backup systems and wherein the backup interface is adapted to receive one or more plugged-in functions of the different external backup systems. The database logic communicates with the backup interface using only a predefined set of extension points, at least some of the extension points being adapted for being implemented by one or more of the plugged-in functions of each of the different external backup systems.

### PRIORITY CLAIM

This application claims benefit of priority of European application no. ______ titled “Database System and Method for External Backup”, filed Jun. 22, 2007, and whose inventors are Andreas Schmidt, Harald Schöning and Wolfgang Obmann.

### INCORPORATED BY REFERENCE

European application no. ______ titled “Database System and Method for External Backup”, filed Jun. 22, 2007, and whose inventors are Andreas Schmidt, Harald Schöning and Wolfgang Obmann, is hereby incorporated by reference in its entirety as though fully and completely set forth herein.

### 1. TECHNICAL FIELD

The present application relates to a database system comprising database logic and a backup interface for external backup.

### 2. THE PRIOR ART

Databases are very important technical tools of modern information societies. Typically, databases are constantly accessed by a number of clients deleting, adding or changing the content of the database. For example in case of a database of a financial institution, there is a continuous flow of transactions performed on the database, which requires the correct technical processing of the corresponding data.

For security reasons it is imperative that backups of parts or the overall database are performed so that none or only non-essential data is lost, in case of a failure in the hardware and/or software of the database system. To this end, it is known in the art to provide backup systems such as mirrored disks, tape streamers or any other combination of hardware and software, which is capable to reliably backup the data of the database system. Such a backup system can be provided internally and therefore be tightly integrated into the operation of the database system. In some situations, however, it is preferable to connect the database system to an external backup system. One reason is that such a backup system might be in a remote place thereby increasing the security for the stored data. Further, manufacturers of external backup systems are highly specialized and may be able to provide an amount of security for the stored data, which cannot be provided by an internal backup system.

Performing a backup of a database system with an external backup system requires typically a high amount of manual work in order to select the various volumes of data to be saved and their destination directories for the backup. Similar efforts are needed to restore the data in a decoupled fashion. Further, the database administrators must put the database in a synchronized state before they can manually perform a backup or a restore.

Alternatively, a lot of programming effort is needed to provide a special interface allowing the database system to directly access a certain external backup system. Whenever the external backup system changes, for example if the content of the database exceeds the capabilities of a certain external backup system, this binding process and all the related effort must be repeated so that the database system can cooperate with the new external backup system.

In view of the above, it is the technical problem underlying one aspect of the present invention to provide a database system which facilitates the binding to new external backup systems in order to overcome at least some of the disadvantages of the prior art.

### 3. SUMMARY OF THE INVENTION

This problem is solved by a method according to claim 1 of the present application. In one embodiment, the database system comprises a database logic adapted to perform database processing and a backup interface for external backup, wherein the backup interface is adapted to connect the database system to a plurality of different external backup systems and wherein the backup interface is adapted to receive one or more plugged-in functions of the different external backup systems.

The database logic communicates with the backup interface using only a predefined set of extension points, at least some of the extension points being adapted for being implemented by one or more of the plugged-in functions of each of the different external backup systems.

Accordingly, the described embodiment provides a number of designated extension points for a defined backup interface enabling a database system to connect to a variety of external backup systems. The standardized interface allows to strictly divide hardware specific aspects of the backup process from the database logic. The plugged-in functions need only to implement the storage specific methods for realizing at least some of the extension points. On the side of the external backup system there is no need to care about database synchronisation or other steps, which may be necessary for the database logic to perform prior to initiating a backup process or a restore process.

The standardized backup interface is preferably specifically adapted for the support of databases. To this end, the preconfigured data are handed over in the form of parameter=value. Further, the name of the backup and the name of the database can be added.

In one embodiment, the database system further comprises a graphical user interface for the control of an external backup, wherein the content of the graphical user interface is at least partly driven by one or more of the plugged-in functions of at least one of the different external backup systems. To this end, the database system may comprise a registry, the registry being adapted to receive entries for the one or more connected external backup systems. Accessing the registry, the graphical user interface can therefore present different backup controls, which are specific for a certain external backup system. As a result, the database system flexibly adapts its user interface to the one or more backup systems, which are presently connected.

Further, the set of extension points may comprise an extension point METHOD, which provides a string for each of the plurality of different external backup systems, the registry being adapted to store the string. Again, the graphical user interface may comprise a configuration screen for an external backup, wherein the screen is adapted to present the string.

The database system may further comprise an extension point PARAMETER, which provides one or more pairs of parameters and their values, which may be specific for one of the external backup systems. The graphical user interface can then comprise a configuration screen for the external backup, wherein the screen is adapted to set the value(s) of the one or more pairs of parameters.

In addition, the database system may further comprise a BACKUP START extension point, a BACKUP PROCESS extension point, a BACKUP END extension point and a BACKUP RESTORE extension point, which prepare, process, finalize and restore a database backup using one of the different external backup systems.

According to another aspect, the present invention is directed to a method of performing a backup of a database using a database system as described above. The method could be implemented using a computer program with suitable instructions stored on a computer readable memory medium.

### 4. SHORT DESCRIPTION OF THE DRAWINGS

In the following detailed description, presently preferred embodiments are described with reference to the following figures:

FIG. 1: A schematic presentation of an embodiment of a database system of the present invention and its interface for various external backup systems;

FIG. 2: An exemplary screen of a registry editor for a database for receiving entries concerning an external database system;

FIG. 3: An example of a configuration screen of a database server adapted to configure an external backup;

FIG. 4: An exemplary screen of a registry of the database presenting three parameters and their values of an external backup system;

FIG. 5: An example of a screen for selection of an external backup;

FIGS. 6, 7: Flow charts illustrating the processing of an external backup in the database system of an embodiment of the present invention; and

FIG. 8: A flow chart illustrating a restore process from a backup created using an external backup system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### 5. DETAILED DESCRIPTION OF THE EMBODIMENTS

In the following, an embodiment of the present invention is described with reference to an XML database, in particular the Tamino database, of applicant. However, it is to be understood that embodiments of the present invention can be used for any kind of database system regardless of its specific design or content. In particular, the database can be centralized or distributed and can be managed using one or more servers. None of these implementation details is essential for the present invention.

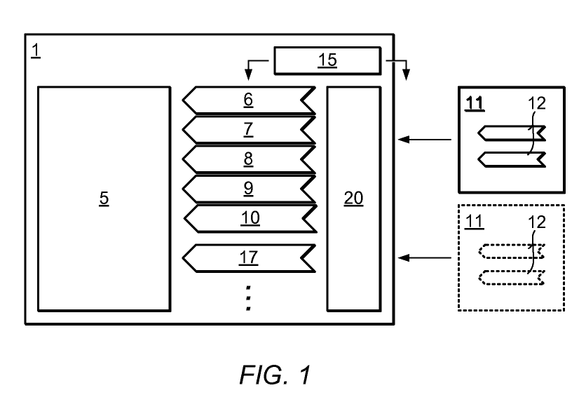

FIG. 1 presents a schematic overview of a database system 1. As can be seen, the database system 1 comprises database logic 5, which could for example be implemented in one or more database servers. The database logic 5 serves to manage the database, for example to receive and to store new entries or to process queries on the data (not shown in FIG. 1) of the database system 1. In order to backup the data, the database system 1 of FIG. 1 may use an internal backup system, if present. However, the database system of FIG. 1 is alternatively or additionally to the internal backup system capable to be interfaced with one of more external backup systems 11, which are shown on the right side of the schematic drawing of FIG. 1.

As indicated by the dashed lines, there might be more than one backup system connected to the database system at the same time. The external backup systems may comprise suitable hard- and software such as a SAN (storage area network) or any other arrangement, which can be used for backup, for example for taking a snapshot of a certain file system or for mirroring a disk or a volume of the database system to another disk with a subsequent split.

FIG. 1 also shows that the various external backup systems 11 communicate with the database system 1 and its database logic 5 via a single interface 20. To this end, a set of extension points 6, 7, 8, 9, 10 and 17 are provided, which link the database logic 5 to the interface 20. Using the set of extension points, the database logic 5 can configure and call any of the connected external backup systems 11 and backup or restore data. As indicated by the dotted line in the lower half of FIG. 1, there may be more than the six extension points shown in FIG. 1. However, there is no direct communication between the database logic 5 and any of the connected external backup systems 11.

The external backup systems 11 on their side comprise one or more plug-in functions 12. The functions 12 may be closely related to the extension points and directly implement them. In one embodiment, they are implemented as .dll files and stored in a suitable library (not shown in FIG. 1). The library and the included functions may be registered in a registry 15 of the database system 1, so that they can be accessed as shared objects, when a backup or a restore operation is to be performed using the respective external backup system 11.

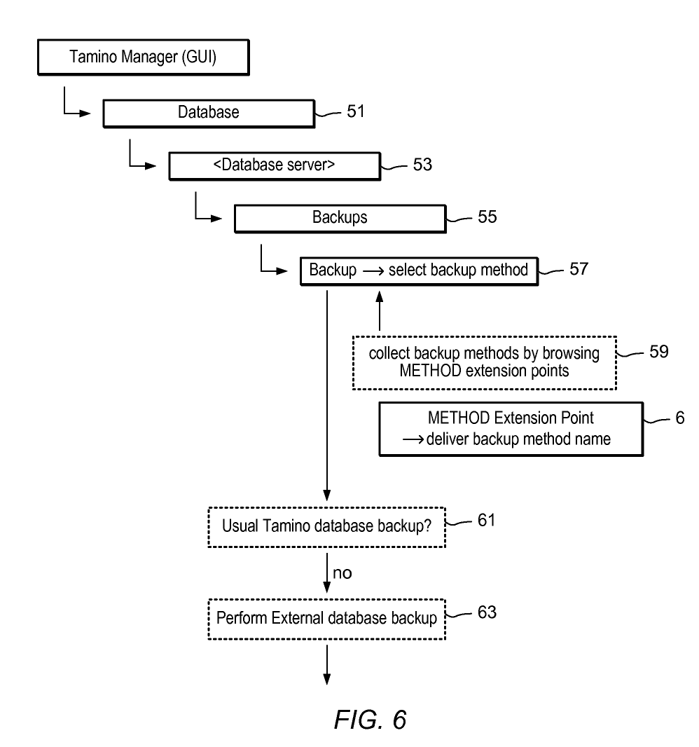

In the following, it will be explained with respect to the flow charts of FIGS. 6-8, how a backup and a restore operation can be configured and carried out using the database system 1 of the embodiment of FIG. 1. In these flow charts, boxes with bold lines indicate steps performed by the implementation of an extension point by a certain external backup system, whereas boxes with thin lines indicate components or steps performed using a graphical user interface, for example of the Tamino database manager of applicant. An arrow inside a box reflects an action to be performed. Boxes with dashed lines, finally, indicate a processing step.

To make a new external backup system 11 known to the database system 1, there are two extension points 6 and 7 for its configuration, which are called extension point METHOD and PARAMETER. They allow to define the environment for the respective backup system. Subsequently, the administration GUI of the database is able to find appropriate entries to configure and initiate database backups using the respective system and the administration GUI can show corresponding GUI elements.

As indicated by the flowchart of FIG. 6, a certain database is at first selected to be managed (step 51) and possibly an appropriate database server (step 53). The GUI then provides an option to select a configuration menu for backups (step 55), wherein at least one backup method (internal or one of a plurality of external backups) can be selected (step 57). Using the above explained METHOD extension point 6, the names of one or more external backup systems are obtained, which can be browsed (step 59). Finally, one of them can be selected. If so, the processing is set in steps 61 and 63 to use the selected external backup and not any internal backups integrated into the database system 1.

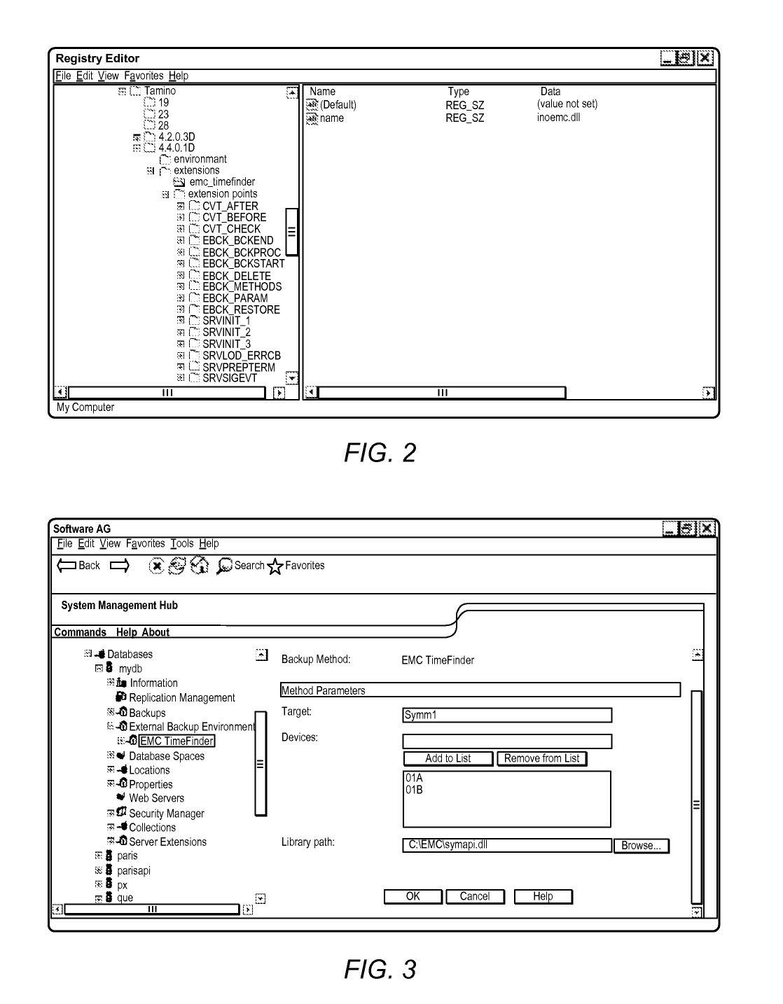

The GUI is able to present these names based on information in the registry 15. FIG. 2 presents a screen shot from a registry editor, indicating a name and a corresponding .dll file for a registered external backup system (“inoemc.dll”). In the GUI itself, the selection of step 57 between an internal backup and one of the registered external backup systems is made using a selection screen, as shown in FIG. 5. Here, the user can decide whether an internal “Tamino Backup” is to be performed or whether an external backup is selected, for example the backup with the name “EMC TimeFinder”.

If the METHOD extension point 6 is available, i.e. an external backup system can be identified, the Tamino's Administration GUI is able to retrieve configuration parameters. Then the PARAMTER extension point 7 has the task to obtain backup specific parameters as pairs of name/value. The parameters are in general very specific to the storage system. For example a so-called NetApp backup system would deliver the name of the filer and the name of the volume, where the database is located. The parameters will be permanently stored in the database's registry.

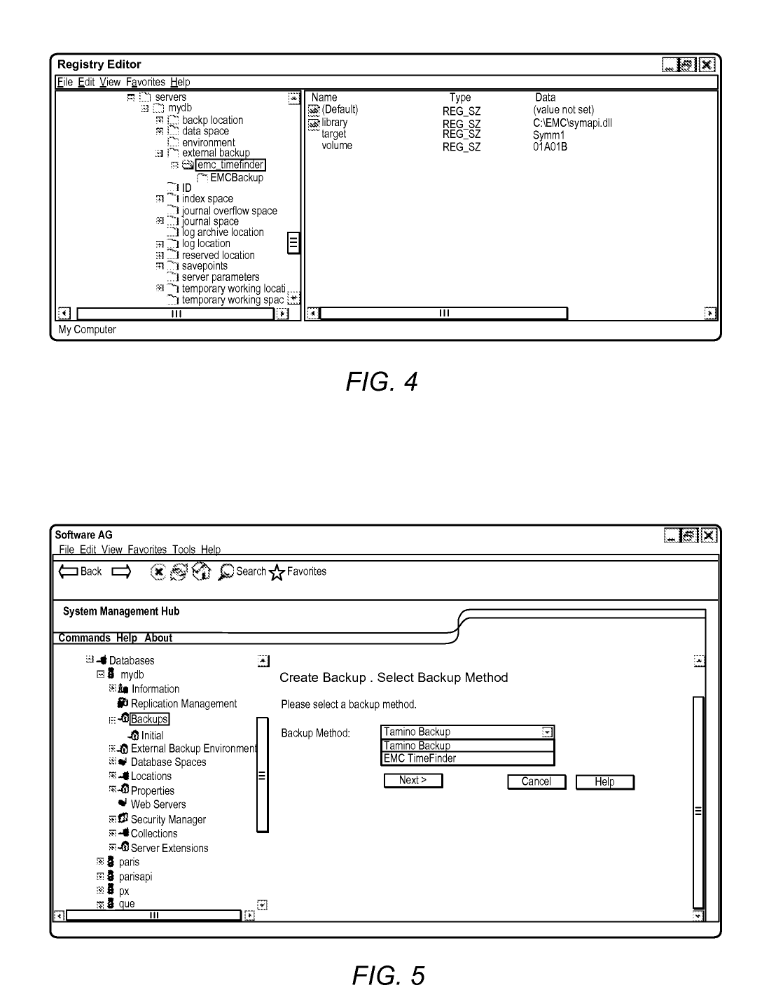

Since plug-in functions are used for the implementation of the extension points, it is possible that these functions also drive the GUI of the database manager. FIG. 3 presents a GUI screen driven by a backup system called EMC TimeFinder. As can be seen, the screen allows to define various parameters such as the target, the devices and the library path of a backup. Selecting these parameters will lead to corresponding entries in the database registry (cf. FIG. 4).

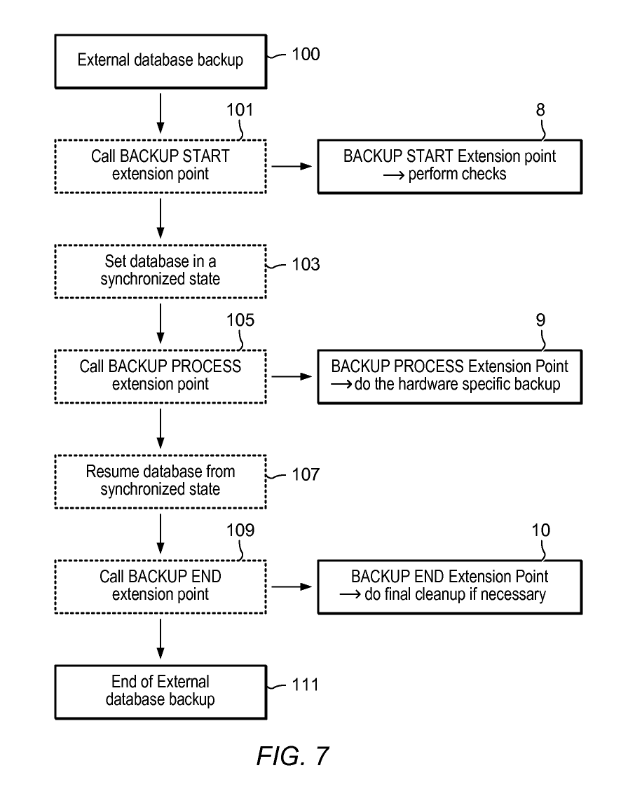

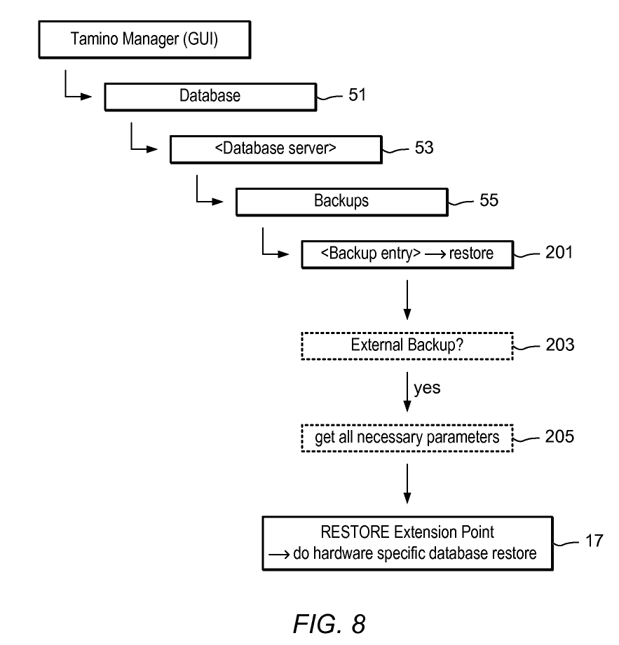

After identification and configuration a newly connected external backup system is ready for use. This is explained in the following with reference to the flowcharts of FIGS. 7 and 8. In a first step 100 (cf FIG. 7), an external backup is initiated. In step 101, the database logic 5 calls the BACKUP START extension point 8. The BACKUP START extension point 8 is designed to prepare a database backup. The specific implementation is able to check if the configuration is valid.

However, at this point the database system is not in a synchronized state. Therefore, the database logic 5 will bring the database system into a synchronized state, for example by closing any open tasks and no longer accepting any further tasks. This is schematically indicated by the step 103 in FIG. 7.

In the next step 105, the BACKUP PROCESS extension point 9 is called by the database logic. The BACKUP PROCESS extension point 9 is designed to execute a database saving in the hardware specific way. Here, a file system snapshot can be performed or a mirror can be split to be used as a backup medium. Calling this extension point after synchronization, the database system is in a state where the data to be freezed is reliable, i.e. no writes to the database will occur. After the backup processing is finished, the database continues its normal operation and is no longer in synchronized state (cf. step 107 in FIG. 7).

The BACKUP END extension point 10 is called in step 109. It enables a final processing of the saved data. The specific implementation of step 109 by an external backup system can do final processing with its created backup medium. Alternatively, this extension point is called, if some error occurred for cleanup. The process ends in step 111.

After the described backup processing has been successfully completed, an entry can be made in the list of backups (no shown) like after any internal database backup. Each backup list entry can be selected by the Tamino Administration GUI, mainly for performing a database restore operation, which will be described below with reference to FIG. 8.

The RESTORE extension point 17 is designed to restore the database from the specific hardware storage previously saved with the corresponding BACKUP extension points. As can be seen from the flow chart of FIG. 8, each backup is selectable with the Tamino Administration GUI using again steps 50-55. The backup entry of the external backup has all the information necessary for a restore operation. Once a restore command has been issued in step 201, it will at first be identified, whether an internal or an external backup is to be restored (step 203). Further, suitable parameters are identified (step 205). Finally, the RESTORE extension point 17 can perform the hardware specific database restore.

It is to be noted that the whole backup and restore process can thus be controlled by the database logic 5 of the database system 1 without any adaptation to the specific backup system presently connected. On the contrary, the backup interface 20 with its extension points and the plug-in functions of the various external backup systems 11 allow to flexibly change from one external backup system 11 to another with a minimum amount of configuration effort.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of embodiments of the invention. Changes may be made in the elements described herein without departing from the spirit and scope of the invention as described in the following claims.

1. A database system comprising:
at least one memory medium storing data;
database logic coupled to the at least one memory medium and adapted to perform database processing; and
a backup interface for external backup, wherein the backup interface is coupled to the database logic, wherein
a. the backup interface is adapted to connect the database system to a plurality of different external backup systems;
b. the backup interface is adapted to receive one or more plugged-in functions of the different external backup systems, and
c. wherein the database logic communicates with the backup interface using only a predefined set of extension points, at least some of the extension points being adapted for being implemented by one or more of the plugged-in functions of each of the different external backup systems.

2. The database system of claim 1, further comprising a display which presents a graphical user interface for the control of an external backup, wherein the content of the graphical user interface is at least partly driven by one or more of the plugged-in functions of at least one of the different external backup systems.

3. The database system of claim 2 further comprising a registry, the registry being adapted to receive entries for the one or more connected external backup systems.

4. The database system of claim 3, wherein the set of extension points comprises an extension point METHOD, which provides a string for each of the plurality of different external backup systems, the registry being adapted to store the string.

5. The database system of claim 4, wherein the graphical user interface comprises a configuration screen for an external backup, the screen being adapted to present the string.

6. The database system of claim 2, further comprising an extension point PARAMETER, which provides one or more pairs of parameters and their values specific for one of the external backup systems;
wherein the graphical user interface comprises a configuration screen for the external backup, the screen being adapted to set the value(s) of the one or more pairs of parameters.

7. The database system of claim 1, further comprising an extension point PARAMETER, which provides one or more pairs of parameters and their values specific for one of the external backup systems.

8. The database system of claim 1, further comprising a BACKUP START extension point, a BACKUP PROCESS extension point, a BACKUP END extension point and a BACKUP RESTORE extension point, which prepare, process, finalize and restore a database backup using one of the of the different external backup systems.

9. The database system of claim 1, further comprising an internal backup system.

10. The database system of claim 1, wherein the one or more of a plurality of different hardware systems for backup are adapted to perform a snapshot and/or a mirror and split of the data of the database system.

11. A method for operating a database system, wherein the database system comprises database logic adapted to perform database processing, wherein the database system also comprises a backup interface for external backup, the method comprising:
connecting the backup interface of the database system to a first external backup system of a plurality of possible external backup systems;
the backup interface receiving first one or more plugged-in functions of the first external backup system, wherein each of the plurality of possible external backup systems is operable to provide a respective set of one or more plugged-in functions; and
the database logic communicating with the backup interface using only a predefined set of extension points, at least some of the extension points being adapted for being implemented by one or more of the plugged-in functions of each of the plurality of possible external backup systems.

12. The method of claim 11, further comprising:
displaying a graphical user interface on a display for the control of the first external backup system, wherein the content of the graphical user interface is at least partly driven by one or more of the plugged-in functions of the first external backup system.

13. The method of claim 12 further comprising:
storing a registry, the registry being adapted to receive entries for respective ones of the plurality of possible external backup systems.

14. The method of claim 13, wherein the set of extension points comprises an extension point METHOD, which provides a string for each of the plurality of different external backup systems, the registry being adapted to store the string.

15. The method of claim 14, wherein the graphical user interface comprises a configuration screen for an external backup, the screen being adapted to present the string.

16. The method of claim 11, wherein the set of extension points further comprises an extension point PARAMETER, which provides one or more pairs of parameters and their values specific for one of the external backup systems.

17. The method of claim 11, wherein the set of extension points further comprises a BACKUP START extension point, a BACKUP PROCESS extension point, a BACKUP END extension point and a BACKUP RESTORE extension point, which prepare, process, finalize and restore a database backup using one of the of the different external backup systems.

18. A memory medium comprising program instructions for operating a database system, wherein the database system comprises database logic adapted to perform database processing, wherein the database system also comprises a backup interface for external backup, wherein the program instructions are executable to:
connect the backup interface of the database system to a first external backup system of a plurality of possible external backup systems;
receive first one or more plugged-in functions of the first external backup system, wherein each of the plurality of possible external backup systems is operable to provide a respective set of one or more plugged-in functions; and
provide communication between the database logic and the backup interface using only a predefined set of extension points, at least some of the extension points being adapted for being implemented by one or more of the plugged-in functions of a respective one of the plurality of possible external backup systems.

19. The memory medium of claim 18, wherein the program instructions are further executable to:
display a graphical user interface for the control of an external backup, wherein the content of the graphical user interface is at least partly driven by one or more of the plugged-in functions of at least one of the different external backup systems.

20. The memory medium of claim 18, wherein the program instructions are further executable to:
store a registry, the registry being adapted to receive entries for the one or more connected external backup systems.

21. A database system comprising a database logic adapted to perform database processing and a backup interface for external backup, wherein
a. the backup interface is adapted to connect the database system to a plurality of different external backup systems;
b. the backup interface is adapted to receive one or more plugged-in functions of the different external backup systems, and
c. wherein the database logic communicates with the backup interface using only a predefined set of extension points, at least some of the extension points being adapted for being implemented by one or more of the plugged-in functions of each of the different external backup systems.

22. The database system of claim 21, further comprising a graphical user interface for the control of an external backup, wherein the content of the graphical user interface is at least partly driven by one or more of the plugged-in functions of at least one of the different external backup systems.

23. The database system of claim 22, further comprising a registry, the registry being adapted to receive entries for the one or more connected external backup systems.
